(19) United States
(12) Patent Application Publication
(10) Pub. No.: US 2003/0067847 A1
(43) Pub. Date: Apr. 10, 2003

(54) Reducing power consumption of rotating disk storage devices

(76) Inventor: Kelan C. Silvester, Portland, OR (US)

Correspondence Address: Timothy N. Trop, TROP, PRUNER & HU, P.C., STE 100, 8554 KATY FWY, HOUSTON, TX, 77024-1805, US

(21) Appl. No.: 09/972,333

(22) Filed: Oct. 5, 2001

(51) Int. Cl. G11B 7/085; G11B 7/005

(52) U.S. Cl. 369/30.23; 369/47.33

(57) ABSTRACT

Excessive power may be consumed by portable processor-based systems that include rotating disk storage devices that are spun continuously. The data on the rotating disk may be read and stored in a randomly accessible memory. Thereafter, the rotation of the disk may be terminated to reduce the amount of rotation time, thereby conserving power. Playback can then proceed from the memory that may be a semiconductor memory in some embodiments.

### BACKGROUND

This invention relates generally to systems and devices that use rotating disk storage mechanisms, including optical drives, such as compact disks and digital versatile disk players.

A variety of processor-based systems may include a rotating disk storage mechanism. Common rotating disk storage mechanisms include hard disk drives, compact disk (CD) drives, and digital versatile disk (DVD) drives, to mention a few examples. In each of these cases, the disk is generally spun in order to read the data off of the disk. Because of the need to have ready data availability, generally the disk continues to spin.

In many cases, the rotating disk storage device is contained in a portable system that is battery powered. Providing the battery power to continuously rotate the rotating disk may substantially drain available power sources.

Examples of systems that include such rotating disk storage devices include laptop computers, and a variety of portable or handheld appliances such as music playback devices, including compact disk players and digital versatile disk players, to mention two examples.

Thus, there is a need for ways to reduce power consumed by rotating disk storage devices.

### BRIEF DESCRIPTION OF THE DRAWINGS

FIG. 1 is a schematic depiction of one embodiment of the present invention;

FIG. 2 is a flow chart in accordance with one embodiment of the present invention;

FIG. 3 is a graphical user interface in accordance with one embodiment of the present invention; and

FIG. 4 is an appliance in accordance with one embodiment of the present invention.

### DETAILED DESCRIPTION

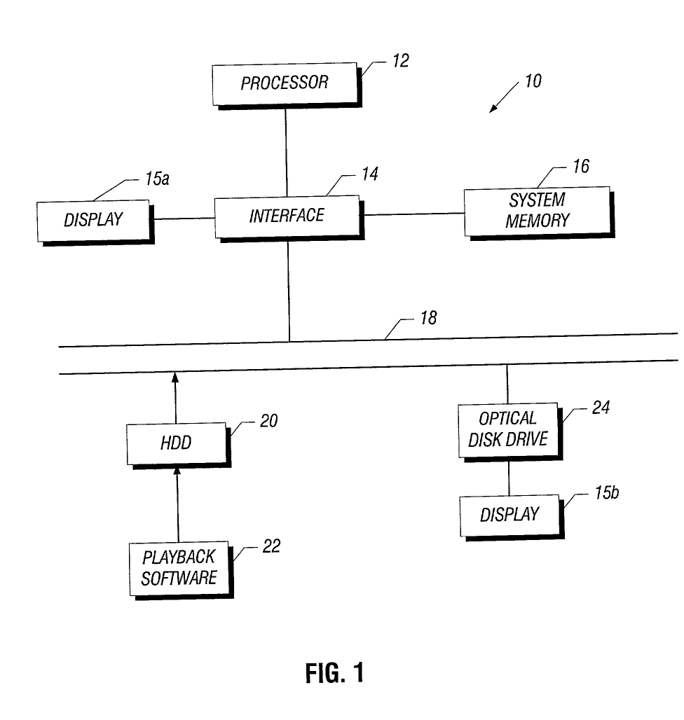

A processor-based system 10, shown in FIG. 1, may be a laptop computer or a handheld device to mention two examples. In one embodiment, the processor-based system 10 is battery powered. Examples of handheld devices include music players, such as portable compact disk (CD) players and portable digital versatile disk (DVD) players. In each case, the system 10 may include an optical disk drive 24 that may be a digital versatile disk or compact disk as two examples.

In some cases, the system 10 may also include a hard disk drive 20 that stores playback software 22. The optical disk drive 24 may be coupled to an interface 14 via a bus 18. The interface 14 interfaces a processor 12 with a display 15a and a system memory 16. In some embodiments, the optical disk drive 24 may include its own display 15b and, in such cases, the display 15a may or may not be provided. A variety of other architectures may be used for the system 10.

The playback software 22 may be stored on a hard disk drive 20 in one embodiment, but, in other embodiments, it may be stored in a semiconductor memory such as a flash memory. For example, in connection with processor-based systems 10 in the form of appliances, the use of flash memory for storing such software may be more typical.

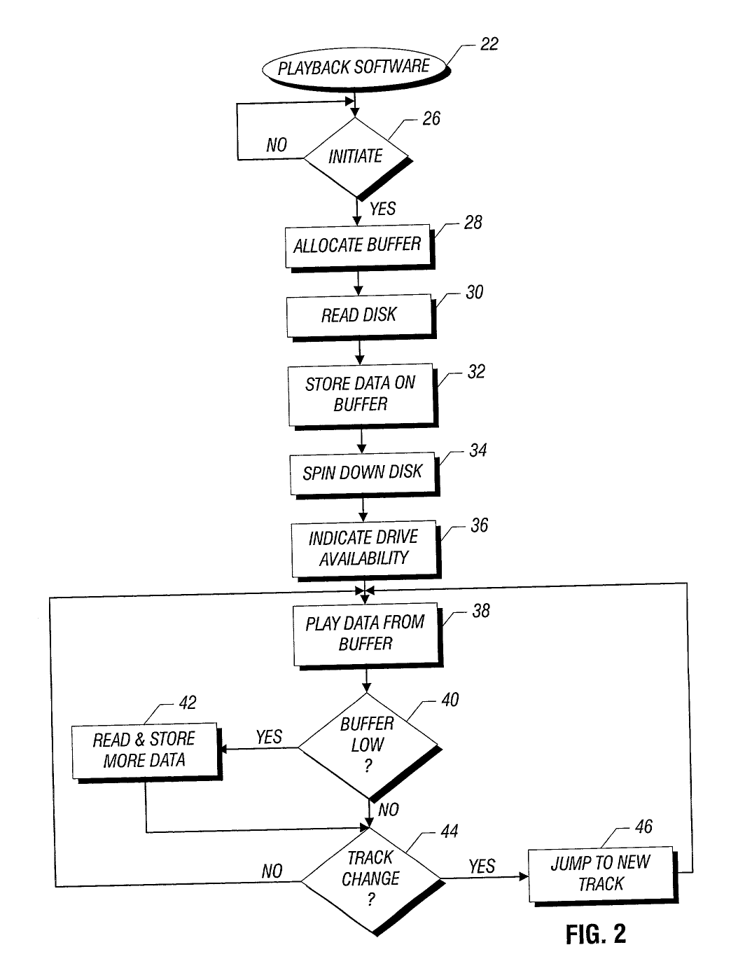

Referring to FIG. 2, the playback software 22 initially determines whether a request for playback of recorded data via a rotating disk storage device has been requested. When a rotatable disk is inserted into the drive 24, the drive 24 automatically spins the disk. The drive 24 generates an interrupt to the system 10 operating system software indicating that a disk has been inserted. The operating system determines that the disk contains certain types of files and finds the application software to play the audio.

The playback software 22 is then initiated, as determined in diamond 26. Upon initiation, the playback software 22 allocates a buffer, for example, on a semiconductor memory, such as the system memory 16, as indicated in block 28. The memory 16 may be a flash memory, static random access memory or a dynamic random access memory, to mention a few examples. The allocated buffer may be of sufficient size to store the data that is contained on the disk inserted into the drive 24 in some embodiments. In one embodiment of the present invention, the entire contents of a disk are read, as indicated in block 30, before initiating playback. In another embodiment, the disk may be read until the allocated buffer is full. In still another embodiment, while the disk is being read, playback may also occur.

The data that is read from the disk is then stored on the buffer, as indicated in block 32. Once all the data has been stored, or the buffer is full, the disk may be spun down, and power may be removed from the drive electronics, as indicated in block 34, in order to reduce power consumption.

Thus, in one embodiment, the entire contents of the disk may be read at one time and then the rotation of the disk may be terminated. In other embodiments, playback may begin immediately or shortly after reading the disk. Thus, the data may be progressively stored and played back onto the buffer. In either case, the amount of time that the disk must spin may be reduced.

After the disk has been spun down after reading the entire disk, the availability of the drive 24 may be indicated, as indicated in block 36. The user may then remove the disk from the drive 24 and may insert other disks as desired.

Thereafter, in one embodiment, the data may be played from the buffer, as indicated in block 38. A check at diamond 40 determines whether the buffer is substantially depleted of data that has not been played back yet. If so, additional data may be read from the disk and stored, as indicated in block 42. Otherwise, a check at diamond 44 determines whether the user has requested a change of playback track. If so, the playback may jump to the new track using conventional techniques, as indicated in block 46. Otherwise, the data playback continues.

As a result, the amount of time that the disk of the rotating disk storage device must spin may be reduced, reducing power consumption. In some embodiments, it is also possible to use the cached or buffered data to implement other features. Because, in some embodiments, the entire contents of the disk have been read out, additional information that may be provided on the disk may be accessed. This information may be accessed at the same time information on the disk, such as a song, is being played back. Thus, other information such as song titles, or information about the song, such as whom is the performing artist, may be displayed on the displays 15a or 15b while the song is being played back.

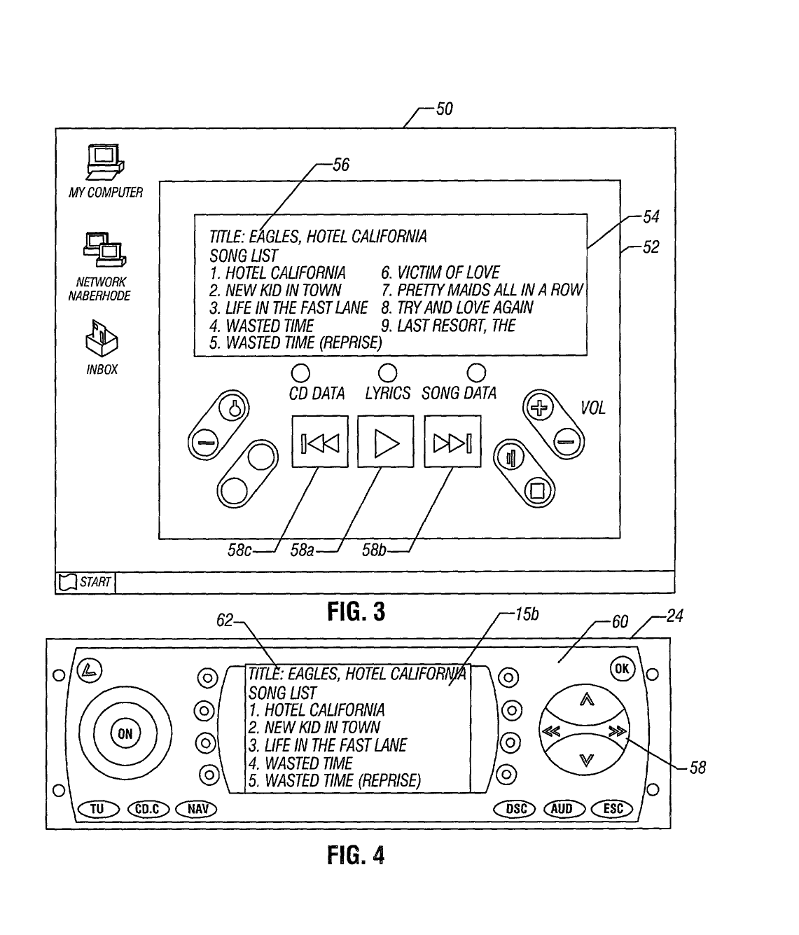

For example, referring to FIG. 3, in accordance with one embodiment of the present invention, a graphical user interface 50 may be displayed, for example, on the display 15a. The graphical user interface 50 may include a window 52 that includes information about the data contained on the disk, such as the title of the disk and the names of the songs on the disk, as indicated at 56. The graphical user interface 50 may include pointer operated controls 58 for playing information stored on the disk, as indicated at 58a, for playing the data at fast forward, as indicated at 58b, or for reversing the playback, as indicated at 58c.

Thus, the additional information may be displayed in the window 54 that may be obtained from the disk and may be displayed at the same time a song (or other information) is being played back. The ability to display this information at any time during playback is a function of the availability of the information in the buffer in random access format and the reading back of the information that is available on the disk before playing back information. Thus, in some embodiments, serially accessible data may be converted to randomly accessible data.

Similarly, in FIG. 4, the system 10 may be implemented in the form of an appliance, such as a compact disk or digital versatile disk playback device. These devices may also be battery powered in some embodiments. In one embodiment, the drive 24 may have its own internal processor 12, interface 14, and bus 18. The drive 24 may also include its own display 15b. In some embodiments, the optical disk drive 24 may include an entire processor-based system 10 and in other embodiments, the drive 24 may be coupled to the rest of a processor-based system 10.

The display 15b may display information 62 that was obtained from the disk and, again, that information may be displayed and accessed at the same time data on the disk, such as music data, is being played by the drive 24. Controls 58 may also be provided.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
reading audio data from a rotating disk in a drive;
buffering said data in a randomly accessible storage device;
reducing the power used by said drive; and
playing back the information after reducing the power used by the drive.

2. The method of claim 1 including reading data from a compact disk.

3. The method of claim 1 including reading data from a digital versatile disk.

4. The method of claim 1 including buffering data in a semiconductor randomly accessible storage device.

5. The method of claim 1 including buffering all of the data on the disk before beginning playback of data on said disk.

6. The method of claim 1 including accessing audio data from the disk and after buffering the audio data, accessing textual data from the disk.

7. The method of claim 1 including determining the amount of buffered data that remains to be played.

8. The method of claim 7 including reading additional data from the disk when the amount of buffered data is below a predetermined level.

9. The method of claim 1 including determining whether a command to change track has been received and, if so, changing the played back track.

10. The method of claim 1 including removing the power to the drive.

11. An article comprising a medium storing instructions that enable a processor-based system to:
read audio data from a rotating disk in a drive;
buffer said data in a randomly accessible storage device;
reduce the power used by the drive; and
play back the information after reducing the power used by the drive.

12. The article of claim 11 further storing instructions that enable the processor-based system to read data from a compact disk.

13. The article of claim 11 further storing instructions that enable the processor-based system to read data from a digital versatile disk.

14. The article of claim 11 further storing instructions that enable the processor-based system to buffer data in a semiconductor randomly accessible storage device.

15. The article of claim 11 further storing instructions that enable the processor-based system to buffer all of the data on the disk before beginning playback of data on said disk.

16. The article of claim 11 further storing instructions that enable the processor-based system to access audio data from the disk and after buffering the audio data access textual data from the disk.

17. The article of claim 11 further storing instructions that enable the processor-based system to determine the amount of buffered data that remains to be played.

18. The article of claim 17 further storing instructions that enable the processor-based system to read additional data from the disk when the amount of buffered data is below a predetermined level.

19. The article of claim 11 further storing instructions that enable the processor-based system to determine whether a command to change track has been received and, if so, changing the played back track.

20. The article of claim 11 further storing instructions that enable the processor-based system to remove the power to the drive.

21. A system comprising:
a processor;
a disk drive; and
a storage coupled to said processor storing instructions that enable the processor to:
read audio data from a rotating disk in the drive;
buffer said data in a randomly accessible storage device;
reduce the power to the drive; and
play back the information after reducing the power to the drive.

22. The system of claim 21 wherein the drive is a compact disk player.

23. The system of claim 21 wherein the drive is a digital versatile disk player.

24. The system of claim 21 including a semiconductor randomly accessible storage device and wherein said storage stores instructions that enable the processor to buffer data in the semiconductor randomly accessible storage device.

25. The system of claim 21 wherein said storage stores instructions that enable the processor to buffer all of the data on the disk before beginning playback of data on said disk.

26. The system of claim 21 wherein said storage stores instructions that enable the processor to access audio data from the disk and after buffering the audio data access textual data from the disk.

27. The system of claim 21 wherein said storage stores instructions that enable the processor to determine the amount of buffered data that remains to be played.

28. The system of claim 27 wherein said storage stores instructions that enable the processor to read additional data from the disk when the amount of buffered data is below a predetermined level.

29. The system of claim 21 wherein said storage stores instructions that enable the processor to determine whether a command to change track has been received and, if so, changing the played back track.

30. The system of claim 21 wherein said storage stores instructions that enable the processor to randomly access said buffered data.
